(19) United States
(12) Patent Application Publication
(10) Pub. No.: US 2026/0080443 A1
(43) Pub. Date: Mar. 19, 2026

(54) METHOD TO ASSESS VALUE OF A TRANSPORTATION SERVICE

(71) Applicant: Inigo LLC, Minneapolis, MN (US)

(72) Inventors: Austin Wilder, Bloomington, MN (US); Jack Nebel, Minneapolis, MN (US)

(21) Appl. No.: 19/327,854

(22) Filed: Sep. 12, 2025

Related U.S. Application Data
(60) Provisional application No. 63/694,685, filed on Sep. 13, 2024.
(60) Provisional application No. 63/762,889, filed on Feb. 25, 2025.

(51) Int. Cl. G06Q 30/0283; G06Q 10/0631; G06Q 30/04; G06Q 50/40; G07C 5/00

(52) U.S. Cl. CPC G06Q 30/0284; G06Q 10/06311; G06Q 30/04; G06Q 50/40; G07C 5/008

(57) ABSTRACT

A method to assess a value of a transportation service can include determining a first provider transportation assessment of a first provider. For example, the first provider transportation assessment can involve receiving first trip information corresponding with a specified travel period associated with the first provider and establishing a first rate configuration including a compound rate structure, the compound rate structure. The compound rate structure can include a base rate, a qualified rate, established based on values the parameters of the first trip information, and at least one cost-adjustment factor. A monetary value of the specified travel period can be terminated, such as based on first the trip information and the compound rate structure of the first rate configuration.

### PRIORITY

This application claims the benefit of priority to U.S. Provisional Patent Application Ser. No. 63/762,889 filed Feb. 25, 2025 and U.S. Provisional Patent Application Ser. No. 63/694,685 filed Sep. 13, 2024, which are incorporated by reference herein in their entirety.

### BACKGROUND

Transportation services encompass the organized movement of people, goods, or resources from one place to another, utilizing various modes such as road, rail, air, water, and even pipelines. These services range from public transit, freight transport, and logistics to courier, shipping, and delivery. They aim to enhance accessibility and connectivity across geographic locations, serving individuals, businesses, and governments. The efficiency, reliability, and timeliness of transportation services are critical, as they impact economic activity, social interactions, and the overall mobility within and between regions.

Within the transportation sector, services are categorized by the type of goods or passengers being moved, the distances covered, and the transport modes used. Passenger transportation includes public options like buses, trains, and airplanes, as well as private options such as taxis, rideshares, and car rentals. Freight transportation involves the transport of raw materials, finished goods, and various commodities, often integrating warehousing and logistics management to streamline the flow and storage of items. These services are supported by infrastructure such as highways, airports, seaports, railways, and transit systems, which are maintained by public or private entities. Transportation companies leverage advanced technologies like gps, digital logistics platforms, and automated systems to optimize routes, monitor shipments, and manage fleets efficiently. With the growth of e-commerce and globalization, transportation services have expanded to include complex, multi-modal networks designed to meet consumer demands for faster, flexible, and on-demand solutions.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 is a diagram of an example of a rate configurator tool.

FIG. 2 is a diagram of an example of a rate configuration process of the rate configurator tool of FIG. 1.

FIG. 3 is an example user interface depicting the definition of a trip aspect of the rate configuration process of FIG. 2.

FIG. 4 is an example user interface depicting the definition of a grouping of the rate configuration process of FIG. 2.

FIG. 5 is an example user interface depicting the definition of a rate type of the rate configuration process of FIG. 2.

FIG. 6 is an example user interface depicting the definition of price and units of the rate configuration process of FIG. 2.

FIG. 7 is an example user interface depicting the definition of price and units of the rate configuration process of FIG. 2.

FIG. 8A depicts an example user interface depicting the definition of rate categories of the rate configuration process of FIG. 2.

FIG. 8B depicts an example user interface depicting the definition of rate categories of the rate configuration process of FIG. 2.

FIG. 9 is a diagram of an example of a price comparison tool.

FIG. 10 depicts an example of an invoice, configured to show line items on a per-student basis.

FIG. 11 is a diagram of an example rate comparison tool.

FIG. 12 is a flowchart showing a method to assess a value of a transportation service.

FIG. 13 is a block diagram of a machine.

### DETAILED DESCRIPTION

Transportation services have become an integral part of modern society, facilitating the movement of people for various purposes including education, work, and leisure. The logistics of coordinating and managing transportation, particularly for specialized groups such as students, present unique challenges, and opportunities for optimization.

In the field of student transportation, various factors must be considered to ensure efficient and cost-effective service delivery. These factors include route planning, vehicle allocation, scheduling, and accounting for special needs of individual riders. The complexity of managing these elements increases with the scale of operations, especially for school districts or educational entities serving large and diverse student populations.

Certain transportation providers provide student transportation services, serving clients such as school districts or other entities that administer student education. Transportation providers or an associated party can generally handle pricing and billing, such as providing invoices for their services at regular intervals. Certain approaches to pricing or billing for transportation providers involve manual processes or very basic calculation tools to quantify a value of their services. Such approaches often involve time-consuming tasks such as route creation, invoice generation, and reconciliation of services rendered with agreed-upon pricing structures. The intricacy of these operations can be compounded by a variability in pricing agreements between transportation providers and their clients, as well as the diverse needs of the riders themselves. For example, such approaches generally lack in comparing relative costs between two different providers or assigning transportation routes to suit an availability, appropriateness, or a fit of a specified transportation provider to a specified transportation task. As a result, such approaches can involve routinely choosing a sub-optimal provider for a given task or conveying obscured cost-value comparisons between two different providers.

In many cases, transportation providers have several client pricing agreements, each differing from one another. For example, school districts or other educational entities can have specified pricing schemes, such as varying from district to district or entity to entity. A pricing scheme can involve costs associated with trips, vehicles, days of operation, numbers of students, and other trip aspects. Similarly, clients such as school districts or other entities can have relationships with multiple transportation providers, e.g., each have pricing structures that differ from one another. It can, in some cases, be unfeasible for client to manually “audit” each invoice they receive from the various providers to ensure they are correctly applying their respective pricing methodologies. Similarly, when choosing a transportation provider to engage, it can be unfeasible for certain clients (e.g., school districts) to compare proposals given the complexity of the various pricing structures and the many pricing factors to come upon a total price.

This document describes systems and methods for assessing the value of transportation services, particularly in the context of student transportation. For example, first trip information can be received, including data corresponding to a specified travel period associated with the first provider. This information can include, specific parameters for multiple respective rides, e.g., mileage, travel duration, travel time-of-day, or location data for each individual ride. The system can receive, establish, or adjust a compound rate structure. For example, the compound rate structure can include a minimum, baseline (e.g., per-vehicle, per-trip, per-day, per-shift, etc.) compensation value, such as ensuring a base level of payment to the first provider for each trip. The compound rate structure can also include a qualified transportation compensation value, which can be established, e.g., by applying a qualified rate to the parameters included in the first trip information. For example, such a qualified transportation compensation value can allow for flexible pricing based on the specific characteristics of each ride. The compound rate structure can further include at least one cost-adjustment factor, which can be adjusted based on specified traveler classifications or trip classifications. For example, the cost-adjustment factor can be used by the system to account for special circumstances or rider needs that may affect pricing. In an example, the system can calculate the monetary value of the specified travel period for the first provider using the first trip information and the compound rate structure of the first rate configuration. The system can also present the first provider transportation assessment via a user interface, e.g., allowing users to determine the cost associated with the first provider. For example, such a user interface can display a detailed breakdown of certain provider-related costs and can also display respective factors influencing them.

In an example, the system can access and process a plurality of simulated, prospective trips, with each prospective trip corresponding to the first trip information. This can facilitate, e.g., comparison of the monetary value of the specified travel period for the first provider with an estimated cost of a second, alternative provider. In an example, based on this comparison, the system can automatically assign the specified prospective trip between the first provider or a second provider, such as to help optimize route assignments and provider selection. For example, “assigning” can refer to an awarding of work (e.g., in the context of a request for proposal (RFP)) or alternatively or additionally refer to day-to-day routing assignment for an existing business arrangement.

In an example, the system can include circuitry to receive and process telemetry data, e.g., on a periodic basis, from a plurality of vehicles in a fleet. This data, received from trip routing, tracking, pathing, or planning software, can correspond with respective specified travel periods. Here, the first provider can be associated with at least one vehicle of the fleet. Such integration can facilitate real-time data collection and processing.

In an example, the system can include circuitry to receive and process traveler data corresponding with the specified travel period. Such traveler data can include specified rider qualifiers, e.g., each corresponding to a financial code such as classified by a governing entity (e.g., state, federal, school district, etc.). For example, the financial code can indicate whether the rider is classified by the governing entity as general education, special education, homeless, eligible for a section 504 route (e.g., pertaining to Section 504 of the Rehabilitation Act of 1973 in Minnesota), or another federal or state-recognized financial code. Alternatively or additionally, the rider qualifier can indicate whether the rider is in need of a ride accommodation (e.g., qualifying for nonstandard travel pricing), such as including a need for a car seat, an aide, a safety vest, a lift vehicle for a wheelchair, solo transport, a barrier vehicle (e.g., including a barrier between a driver and a passenger), or a seat belt locking cover.

In an example, the system can include circuitry to determine and establish or adjust the compound rate structure according to at least one of deadhead time or intertrip time. For example, deadhead time or intertrip time can each be determined based on an amount of time a transportation provider is traveling without a paying transportee onboard, such as from a vehicle storage facility at a beginning of a trip or a period between different riders. The cost-adjustment factor in the rate configuration can then be applied based on this determined amount of deadhead time, allowing for more accurate and fair pricing.

Once the monetary value for the specified travel period is determined, the system can automatically generate an invoice of fees due to the first provider. This invoice can then be electronically delivered to either the first provider or to a recipient of services on behalf of the first provider (e.g., a school district), streamlining the billing process. The system's comparative capabilities extend to multiple providers. For example, the system can determine transportation assessments for different providers, each with their own rate configurations and trip information. This allows for easy comparison of costs between different providers, which is particularly useful in competitive bidding processes or when evaluating multiple vendors for route assignments.

Systems and methods described herein provide an approach to correctly and efficiently invoicing clients for transportation services. In an example, invoices can be created for transportation services automatically, based on received data from a transportation service or received data from a rider. Such techniques can help enable a client to compare proposals from different student transportation providers to determine which best suits the needs of the client, such as, for example, by being the least expensive when applied to the specific requirements of the client or third party. For example, tools described herein can be used to evaluate multiple bids in a competitive bid process by using actual usage data and calculating an invoice for multiple rate structures to see which is most cost effective. Tools described herein can also be used to determine which of multiple vendors with different pricing and or rate structures is most cost effective, energy efficient, etc. to assign a given route to.

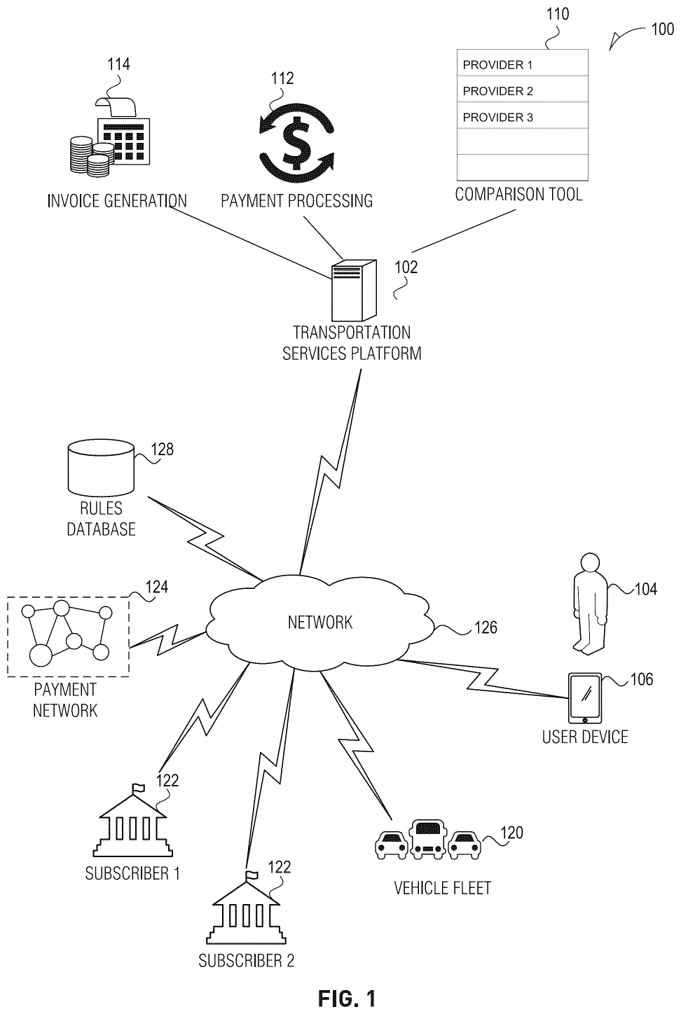

FIG. 1 is a diagram of an example of a rate configurator tool 100. The rate configurator tool 100 can be implemented as a process carried out on a computing device. In an example, a transportation services platform 102 can perform one or more operations, e.g., provider comparison 110, payment processing 112, or invoice generation. For example, the comparison 110 operation can compare trip parameters corresponding with a plurality of different providers (e.g., comparing types of offered services, pricing methodologies, user-ratings of different services, history-based reliability of different services, etc.). The transportation services platform 102 can be communicatively coupled with a network 126, which can access any one of a rules database 128, a payment network 124, or on-board computer data from a vehicle in a vehicle fleet 120. In an example, one or more subscribers 122 can access the network 126 (e.g., to transmit or received data from any of the transportation services platform 102, the rules database 128, the payment network 124, or the vehicle fleet 120). In an example, the network 126 can also be accessed by a user 104 (e.g., a person associated with or representing an individual subscriber 122, or a third party), such as via a user device 106. Generally, the rules database 128, the payment network, and the comparison tool 110 of the transportation services platform 102 can each be accessed by various devices in the network to help an end user (e.g., user 104 via user device 106) determine a provider that is most appropriate for a given transportation task. In an example, once a transportation task has been completed (e.g., based on feedback or confirmation from the on-board computer data from a vehicle in the vehicle fleet 120, a user input received from the user device 106 indicative of a completed transportation task, etc.), the transportation services platform can initiate the payment processing operation 112, the invoice generation operation 114, or a combination thereof to perform a monetary transaction corresponding with the transportation task.

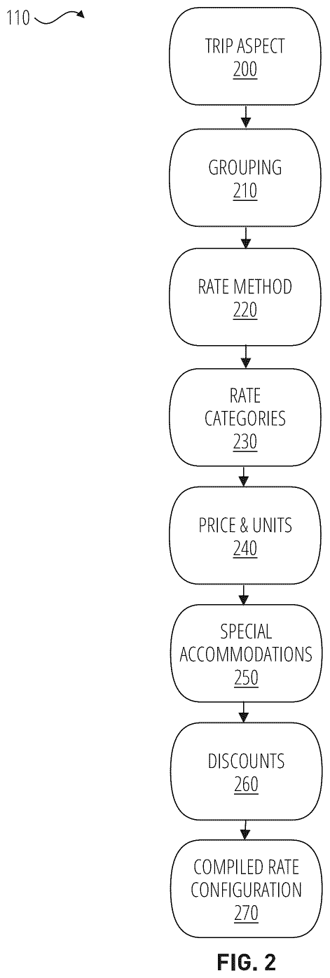

FIG. 2 is a diagram of a process used to define the rate configuration 110 of the rate configurator tool 100. Defining a rate configuration 110 can be implemented as a process carried out on a computing device. The process used to define the rate configuration 110 can include selecting a trip aspect 200, selecting a grouping 210, selecting a rate method 220, defining one or more rate categories 230, defining price and units 240, defining special accommodations 250, defining discounts 260, and defining a rate configuration 270.

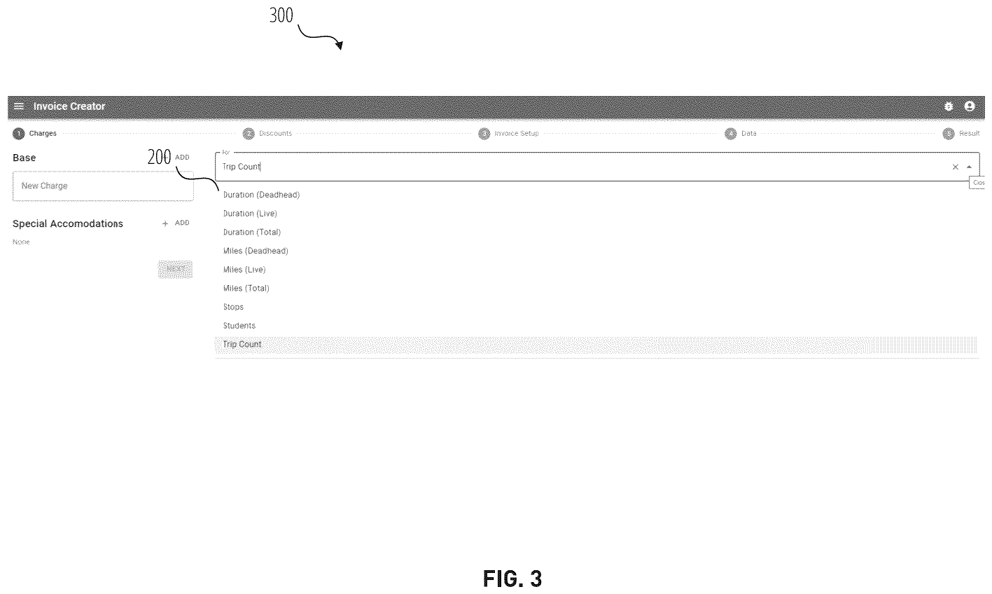

Trip Aspect 200. To create a rate configuration 110 for use in the rate configuration tool 100, a user can start by selecting a trip aspect 200 that has a pricing allocated to it. Selecting a trip aspect 200 can be implemented as a process carried out on a computing device. FIG. 3 is an example user interface 300 depicting the selection of a trip aspect 200 to create a rate configuration 100 as depicted in FIG. 2. Exemplary trip aspects that can be selected include mileage, time, count of trip, count of stops, count of students riding, and any other aspect of a trip that can have a pricing allocated to it. The mileage used as a trip aspect can include the total mileage of a trip (e.g., total miles put on a vehicle from the time it leaves a garage to the time it is parked there after a trip), live mileage (e.g., miles driven while passengers are onboard), deadhead mileage (e.g., miles driven from a garage to a first passenger pickup or from a last passenger drop off to a garage), intertrip mileage (e.g., miles between trips when a vehicle does not return to a garage), or any other subset of mileage traveled by a vehicle. The time used as a trip aspect can include the total time of a trip (e.g., total elapsed time from when vehicle leaves a garage to the time it is parked there after a trip), live time (e.g., elapsed time while passengers are onboard), deadhead time (e.g., elapsed time while driving vehicle from a garage to a first passenger pickup or from a last passenger drop off to a garage), intertrip time (e.g., elapsed time between trips when a vehicle does not return to a garage), or any other subset of time that measures the use of a vehicle. The count of trip can be, for example, the number of times a route is driven. The count of stops can include, e.g., the number of stops per route, or the number of stops accumulated over a period of time. The count of riders can include, e.g., the number of riders per route or the number of riders accumulated over a period of time. In an example, the riders can be students.

As a part of selecting a trip aspect, the rate configurator tool 100 can also use one or more rounding methodologies to be associated with a trip aspect 200. Selecting a rounding methodology can be implemented as a process carried out on a computing device. A user can thus provide a rounding methodology to the rate configurator tool 100 while defining the trip aspect 200. Exemplary rounding methodologies can include rounding to the nearest 0.1, 1, 5, 10, and the like. The rounding methodology can include logic for determining when to always round up, when to truncate, or other logic for rounding. For example, a rounding methodology may provide that a number such as 1.25 always rounds up to 2, and 1.24 and below rounds down to 1. In this way, a user of the configurator tool 100 can define a rounding methodology to be applied to a trip aspect 200 consistent with a pricing scheme required by a client such as a school district or by a transportation provider.

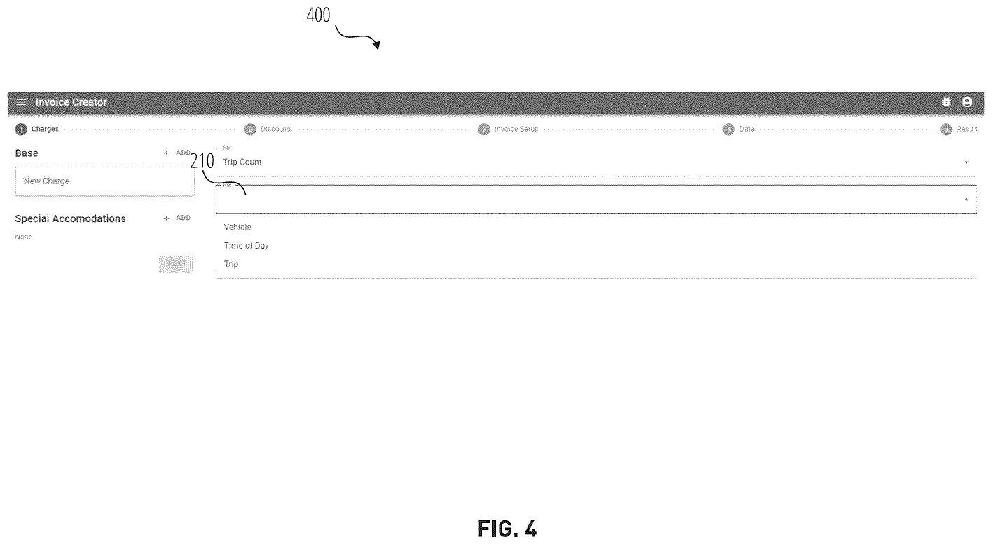

Grouping 210. Defining a rate configuration 110 can also include defining a grouping methodology 210. Defining a grouping 210 can be implemented as a process carried out on a computing device. FIG. 4 is an example user interface 400 depicting the selection of a grouping 210 to create a rate configuration 100 as depicted in FIG. 2. The grouping 210 defines a category by which a trip aspect 200 is grouped. By selecting a grouping 210 as disclosed herein, a user can define the period over which a trip aspect 200 is measured. For example, the rate configurator tool 100 can evaluate mileage cost for each trip, as one grouping, or alternatively, the mileage cost for the vehicle for the day (which may be running multiple trips), or as yet another alternative, as mileage accrued during a certain time of the day. Exemplary groupings 210 can include per vehicle, time of day, trip, or rider. By way of example, where a trip aspect 200 is based on mileage and a grouping 210 is per vehicle, the trip aspect 200 and grouping 210 may be applied as mileage per vehicle. Any other combination of trip aspect 200 and grouping 210 can be used, including, by way of example, mileage per trip, mileage per time of day, time per vehicle, time per trip, time per time of day, mileage per rider, time per rider, and the like. When a grouping 200 of time of day is used, this can group the trip aspect into one or more discrete time periods in a day. For example, a grouping 200 of time of day may be per prime time (e.g., 5:00 AM to-10:00 AM and 2:00 PM to 5:00 PM) and/or per off time (e.g., midday times such as 10:00 AM to 2:00 PM).

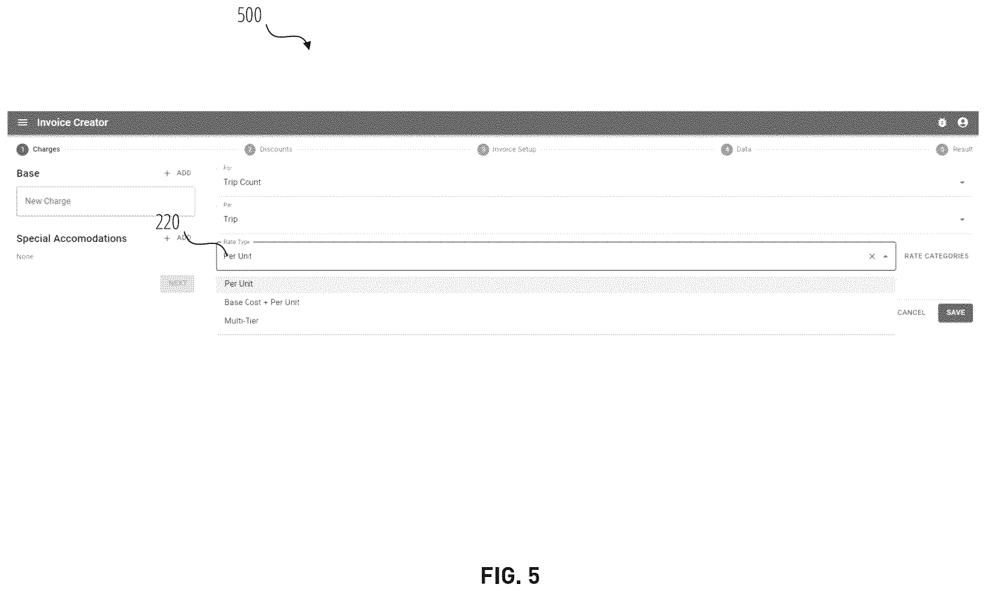

Rate type 220. Defining a rate configuration 110 can also include defining a rate type 220. Defining a rate type 220 can be implemented as a process carried out on a computing device. The rate type 220 defines the manner in which a pricing is associated with the trip aspect 200. FIG. 5 is an example user interface 500 depicting the selection of a rate type 220 to create a rate configuration 100 as depicted in FIG. 2. Exemplary rate types can include flat per unit rate, base rate plus per unit rate, progressive-tiered rates where the unit rate can change as a factor of the total units, and the like. A rate type 220 of flat per unit rate can be a certain price per certain amount of the trip aspect 200. An example of a flat per unit rate may be $2 per mile where a mileage or subset of mileage is used as a trip aspect 200. A rate type 220 of a base rate plus per unit rate can be a base price per grouping plus a flat rate per trip aspect 200 as described above. An example of a base rate plus per unit rate may be $100 plus $2 per mile where a mileage or subset of mileage is used as a trip aspect 200 and per trip is used as a grouping 210. A rate type 220 of a progressive-tiered rate can be one where the per unit rate changes as a factor of the total units, and can also optionally include a base rate. An example progressive-tiered rate may be $1 per mile for the first 10 miles, then $2 per mile for 11-20 miles, $2.25 per mile for miles 21 and over where a mileage or subset of mileage is used as a trip aspect 200. An example progressive-tiered rate with a base rate may be $100 plus $1 per mile for the first 10 miles, then $2 per mile for 11-20 miles, $2.25 per mile for miles 21 and over where a mileage or subset of mileage is used as a trip aspect 200 and per trip is used as a grouping 210. The foregoing are merely examples meant to illustrate the rate types and are not meant to be limiting in any way.

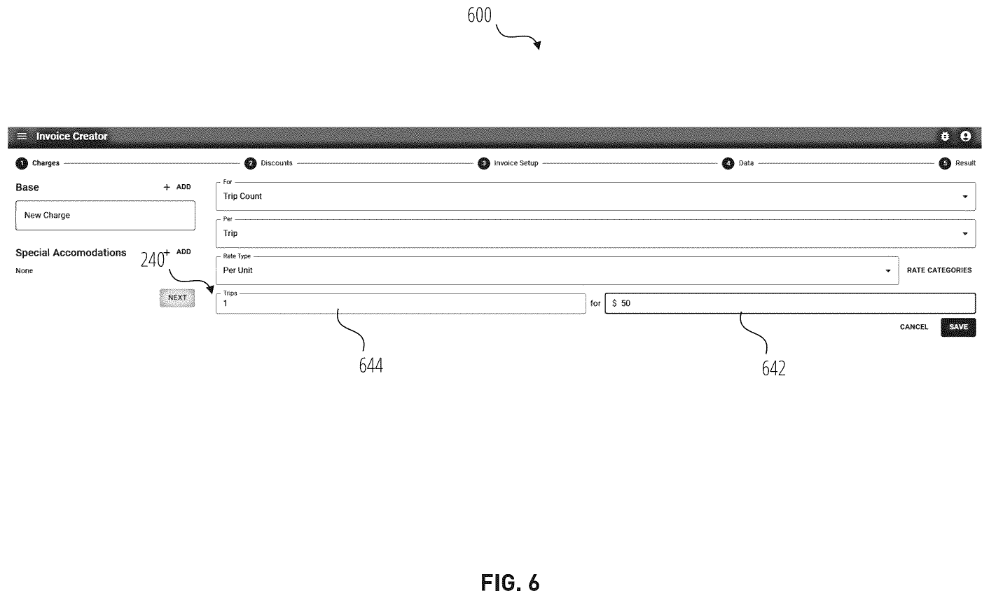

Price and units 240. Defining a rate configuration 110 can also include defining the price and units 240. Defining the price and units 240 can be implemented as a process carried out on a computing device. Defining the price and units 240 includes providing the actual price to apply per the selected unit of the associated trip aspect 200. FIG. 6 is an example user interface 600 depicting the definition of price and units 240 to create a rate configuration 100 as depicted in FIG. 2. In the example shown in FIG. 6, the trip aspect 200 is count of trip, the grouping 210 is per trip, the rate type 220 is per unit, and the price and units 240 are a price 642 of $50 and the units 644 are 1. Thus, in this example, the price rate to apply is $50 per 1 trip.

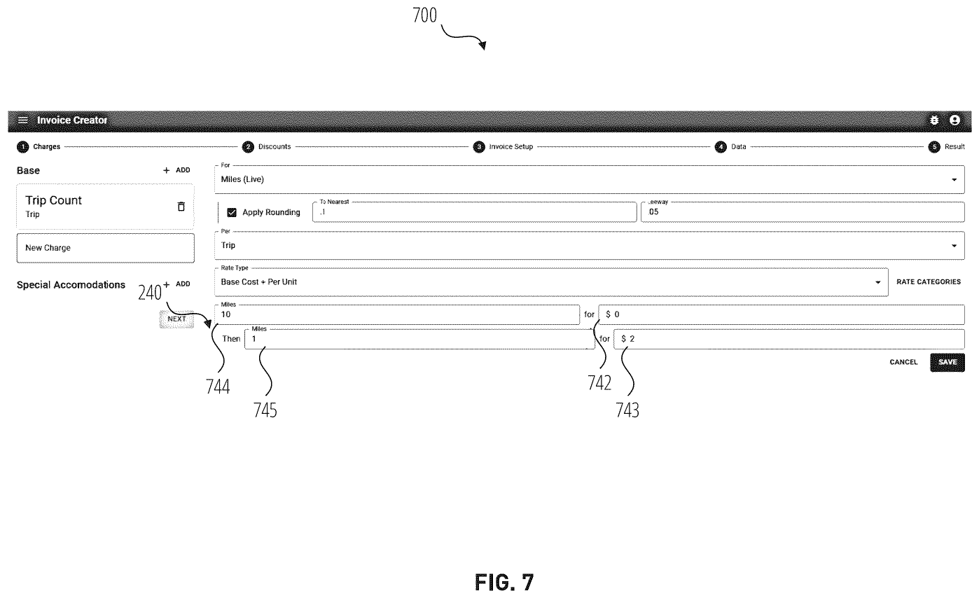

FIG. 7 is an example user interface 700 depicting the definition of price and units 240 to create a rate configuration 100 as depicted in FIG. 2. In the example shown in FIG. 7, the trip aspect 200 is live miles, a rounding methodology is to round to the nearest 0.1 with 0.05 as the over/under cutoff, the grouping 210 is per trip, the rate type 220 is base cost plus per unit, and the price and units 240 are a base cost consisting of a first price 742 of $0 and a first unit 644 of 10 and a second price 743 of $2 and a second unit of 1. Thus, in this example, the price rate to apply is a base of $0 plus $2 per mile for every mile above 10 miles.

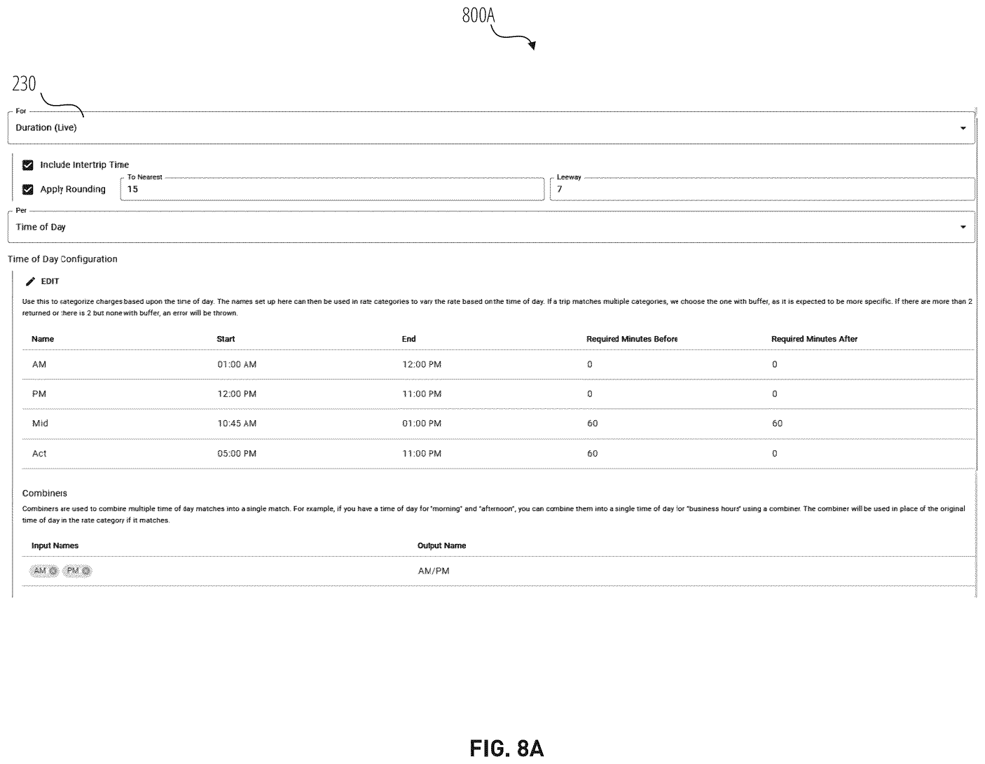

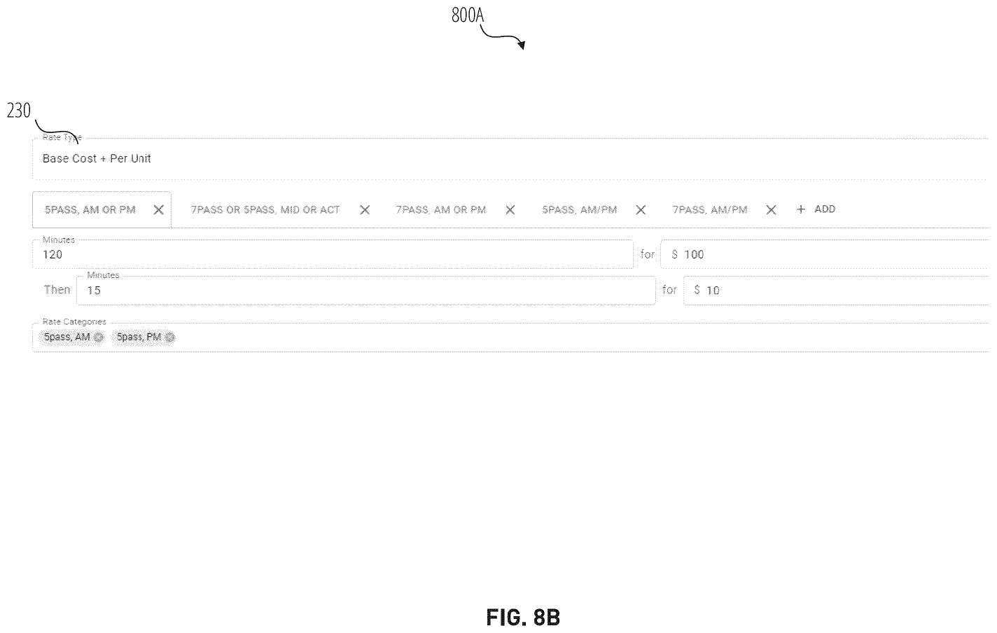

Rate Categories 230. In an example, one or more rate categories 230 are defined before providing price and units 240. Defining rate categories 230 can be implemented as a process carried out on a computing device. A user can define an unlimited number of rate categories that 230 that are tied to aspects of rider data or trip data that the trip aspect 200 is price dependent on. Rate categories 230 thus allow different pricing to apply for the different aspects of trip or rider data. For example, it can allow different pricing to apply for different types of vehicles that are used, different times of day, different billing codes associated with a rider, and the like. FIGS. 8A-8B are an example user interfaces 800A and 800B depicting the definition of rate categories 230 to create a rate configuration 100 as depicted in FIG. 2. In the example depicted in FIGS. 8A-8B, a trip aspect 200 is live duration, including intertrip time and with a rounding methodology defined, a grouping 210 is time of day, and rate categories 230 are defined based on the time of day and vehicle types. In this example, the time of day portion of the rate categories 230 are broken into “AM/PM” and “Mid-Day” based on the time of day. In other words, different rates apply depending on whether the trip is undertaken during the “AM/PM” time period or whether it is undertaken in the “Mid-Day” time period. In this example, the “AM/PM” is defined as any trip occurring between 1:00 AM and 12:00 PM or between 12:00 PM and 11:00 PM. A “Mid-Day” category is defined as a time from 10:45 AM to 1:00 PM, and an “Activities” time period is defined as a time from 5:00 PM to 11:00 PM. Because there can be overlap in the time period definitions, the rate configurator 100 can allow a user to define logic for deciding which time period to apply to a trip. For example, the start time, end time, or percent of a trip that occurs in one time period can be used to determine which time period in which to categorize the trip. One additional implementation that allows for certain trips to be further included or excluded may be to define the ‘Required Gap Time Before’ or ‘Required Gap Time After’ a specific time period in which there cannot be another trip in order for a given trip to be categorize in that time period. For example, if there is a required gap time before Midday time period of 30 minutes and there is a trip that is from 10:00 AM-10:35 AM and a second trip from 10:55 AM-11:30 AM, then the 10:55 AM-11:30 AM trip may be included in the AM time period instead of the Mid-day time period. This may typically be used in considering whether a given driver has adequate time to return to home or to base prior to driving the Mid-day trip. In the example depicted by FIGS. 8A and 8B, rate categories 230 are defined based on the time periods described above in addition to the type of vehicle used. Specifically, the following 5 rate categories 230 are defined: 5-passenger vehicle during AM or PM (1:00 AM to 12:00 PM or 12:00 PM to 11:00 PM), 7-passenger vehicle during Mid-Day or Activities times (10:45 AM to 1:00 PM or 5:00 PM to 11:00 PM), 7-passenger vehicle during AM or PM (1:00 AM to 12:00 PM or 12:00 PM to 11:00 PM), 5-passenger vehicle during AM and PM (1:00 AM to 12:00 PM and 12:00 PM to 11:00 PM), and 7-passenger vehicle during AM and PM (1:00 AM to 12:00 PM and 12:00 PM to 11:00 PM). For each such rate category 230, a specific rate method 220 and price and units 240 can be defined. In this way, the rate configurator 100 can discriminate pricing based on different categories such as time of day, vehicle type, rider financial codes, and any other aspect selected by a user. In the example depicted by FIGS. 8A and 8B, the rate category 230 of 5-passenger van during AM or PM (1:00 AM to 12:00 PM or 12:00 PM to 11:00 PM) has a rate type 220 of base cost plus per unit, and a pricing and units of 120 minutes for $100 and then 15 minutes for $10. In other words, the rate category is charged as $100 for the first 120 minutes and then $10 per each subsequent 15 minutes (using the rounding methodology described above).

Special accommodations 250. The rate configurator 100 can incorporate pricing associated with special accommodations 250. Defining special accommodations 250 can be implemented as a process carried out on a computing device. The rate configurator 100 thus allows a user to define special accommodations 250 and pricing associated with them. Special accommodations 250 can be trip data that vary based on the specific rider(s) on a given trip or vary based on specific vehicle equipment. By way of example, riders may require aides/monitors, wheelchair equipped vehicles, car seats, booster seats, safety vests, solo transportation required, barrier vehicle, and other accommodations. By allowing such special accommodations 250 to be defined with associated pricing, the rate configurator 100 can produce final pricing results that take these special accommodations 250 into account.

Discounts 260. The rate configurator 100 can incorporate pricing structures that include discounts 260. Defining discounts 260 can be implemented as a process carried out on a computing device. The rate configurator 100 thus allows a user to define discounts 260 that can be applied to the final computation of trip pricing. In an example, discounts 260 can be applied after a price rate has been otherwise defined. Discounts 260 can be applied in other ways as well and are not particularly limited. Discounts 260 can have any structure desired by a user. Example structures for discounts 260 include a flat percentage discount, tiered percentage discount, tiered absolute discount, tiered specific discount, and the like. Discounts 260 can be applied on a universal basis or as determined by the volume of one or more trip aspects 200 or student data, including, for example, vehicle count, trip count, and student count. Such volume can be grouped on a daily, weekly, biweekly, monthly, or other basis. By way of example, a discount 260 may be 10% off all rates for summer school, $10 off the base trip rate when more than 10 vehicles are in use for at least 3 days in the week being invoiced, $10 off the base trip rate when more than 10 vehicles are in use for at least 3 days in the week being invoice and additionally $12 off the base trip rate when more than 11-20 vehicles are in use for at least 3 days in the week being invoiced. The foregoing are merely examples meant to illustrate the discount types and are not meant to be limiting in any way.

Compiled rate configuration 270. Following the definition of a trip aspect 200, the definition of a grouping 210, the definition of a rate method 220, the definition of rate categories 230, the definition of price and units 240, the definition of special accommodations 250, and the definition of discounts 260, a compiled rate configuration 270 can be fully defined taking into account the foregoing elements. Alternatively, additional instances of the foregoing elements (i.e., trip aspect 200, grouping 210, rate method 220, rate categories 230, price and units 240, special accommodations 250, and discounts 260) can be defined for additional trip aspects 200. In this way, the rate configurator tool 100 can have any number of rate structures defined for any desired combination of trip aspect 200, grouping 210, rate method 220, rate categories 230, price and units 240, special accommodations 250, and discounts 260 that are ultimately compiled into a compiled rate configuration 270. For example, a user may create a compiled rate configuration 270 that takes into account any combination of a first rate structure based on a mileage trip aspect 200, a second rate structure based on a time trip aspect 200, a third rate structure based on a trip count trip aspect 200, a fourth rate structure based on a count of stops trip aspect 200, a fifth rate structure based on a number of riders trip aspect 200, and an n^{th} rate structure based on any other trip aspect 200. The various rate structures can be added, subtracted, or otherwise combined with each other as appropriate to provide for a final compiled rate configuration 270 that is applied to rider data 120 and trip data 130 to determine a total price of a trip. Compiling a compiled rate configuration 270 can be implemented as a process carried out on a computing device.

In an example, rather than defining a rate configuration 110 as shown in FIG. 2, the rate configurator tool 100 can save and load pre-defined rate configurations. These can be rate configurations defined by a user using the process shown in FIG. 2 that have been saved for subsequent use. These can also be rate configurations provided by an outside party such as a customer. In an example, rate structures are stored on a storage media as files encoded in a JSON format.

Rider Data 120. Turning back to FIG. 1, the rate configurator 100 evaluates rider data 120 using a rate configuration 110 as part of a price determination 140. Evaluating rider data 120 can be implemented as a process carried out on a computing device. The rider data 120 can include any information about one or more riders who are subject to the transportation services for which the price must be determined. The rider data 120 can include any information about a rider, which in some cases includes data regarding riders who are students at an educational institution. Exemplary rider data 120 includes: unique identifiers, financial or billing codes (e.g., general education, special education, Mckinney-Vento, and the like), pickup address, drop off address, pickup trip identifier, drop off trip identifier, date of trip, information about person or entity who requests transportation on rider's behalf (e.g., parent, guardian, school district, social worker, etc.), special transportation accommodation requirements (e.g., aide, wheelchair lift, safety vest, car seat, booster seat, solo transportation required, barrier vehicle, and the like), first and/or last name of rider, date of birth of rider, and any other information that might impact the rate charged for transportation services. Rider data 120 can be provided for any number of riders for any number of trips for any time period as desired by a user. Rider data 120 can be provided to the rate configurator 100 in electronic form, such as in a spreadsheet, list, database, or any other electronic form. The rate configurator 100 can automatically process rider data 120 without requiring manual entry by a user. The rate configurator 100 can also accept manually entered rider data 120.

Trip Data 130. The rate configurator 100 evaluates trip data 130 using a rate configuration 110 as part of a price determination 140. Evaluating trip data 130 can be implemented as a process carried out on a computing device. The trip data 130 can include any information about a trip for which the price must be determined. Exemplary trip data 130 includes: unique identifiers (e.g., for a recurring trip or for a single instance of a trip, etc.), date of trip, information regarding vehicle(s) to be used for the trip (e.g., unique vehicle identifier, vehicle seating capacity, vehicle type, etc.), time information (e.g., start time, pickup times, drop off times, end times, etc.), distance information (e.g., miles, start to pick up miles, pickup to drop off miles, drop off to end miles, etc.), geolocation information (e.g., start coordinates, pickup coordinates, end coordinates, etc.), or any other data relevant to one or more trips for which a pricing must be determined. Exemplary vehicle types that can be included as trip data 130 include: sedan, van, mini-van, SUV, a city bus, Type A bus, Type B bus, Type C bus, Type D bus 7-passenger mini-van, 10 passenger van, and the like. Trip data 130 can be provided for any number of trips for any number of riders for any time period as desired by a user. Trip data 130 can be provided to the rate configurator 100 in electronic form, such as in a spreadsheet, list, database, or any other electronic form. The rate configurator 100 can automatically process trip data 130 without requiring manual entry by a user. The rate configurator 100 can also accept manually entered trip data 130.

Price determination 140. The rate configurator 100 applies a rate configuration 110, which has been defined by a user, to rider data 120 and/or to trip data 130 to determine a price associated with providing transportation services for the trips reflected in the trip data 130 and riders reflected in the rider data 120. Applying a rate configuration 110 to rider data 120 and/or trip data 130 can be implemented as a process carried out on a computing device. The rate configurator 100 synthesizes all trip data, student data, and all defined parameters of the rate configuration 110 to produce a price in any chosen method of costing. Exemplary methods of costing include cost of trip, cost of vehicle, cost of student, and the like. The rate configurator 100 can thus provide pricing in any manner requested by a client such as a school district or other entity requesting transportation services.

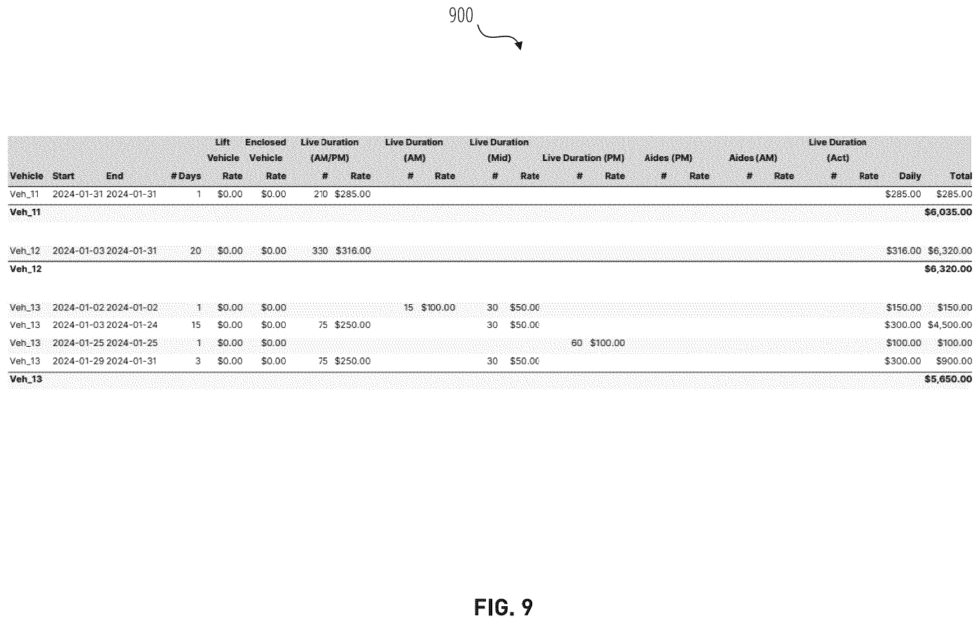

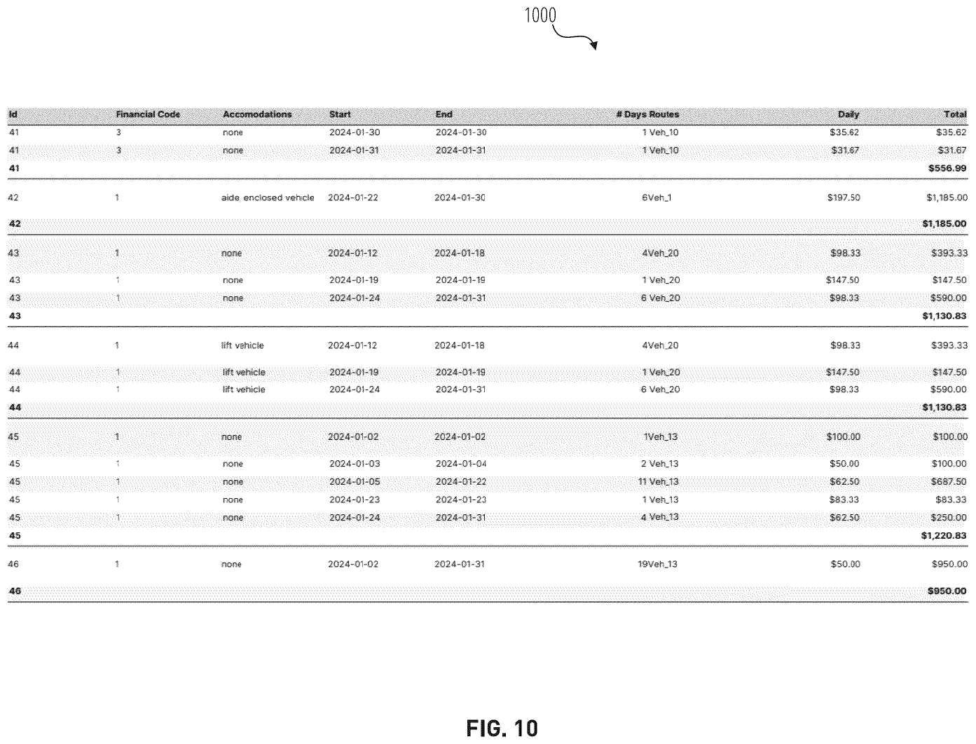

Generating invoice 150. The rate configurator 100 can generate an invoice 150 based on the price determination 140. Generating an invoice 150 can be implemented as a process carried out on a computing device. The rate configurator 100 can generate an invoice having any form desired by a user. For example, an invoice can be configured to show line items on a per-vehicle basis, such as that shown on the invoice 900 depicted by FIG. 9. An invoice can also be configured to show line items on a per-student basis, such as that shown on the invoice 1000 depicted by FIG. 10. The grouping on which the invoice is based, such as per-vehicle as shown in FIG. 9 or per-student as shown in FIG. 10, can be any grouping desired by a user. The grouping on which an invoice is generated can be the same as or different than any grouping(s) used in the rate configuration that was used to generate the invoice. A user can configure an invoice so that the output prices can be obtained for variables that do not have specific rates defined. For example, if the rates are only defined based on trips or vehicles, a user can configure an invoice to show price for any given student or for students associated with one or more financial codes. The rate configurator 100 can thus allow a user to define additional parameters for generating invoices. Examples can include methods of splitting costs evenly across students by vehicle or by trip, or methods of splitting vehicle or trip costs by the ratio of miles travelled for each individual student. Examples of parameters used to provide financial code calculations on an invoice can also include allocating vehicle trips, time of day segments, and other groupings to one or more financial codes via a separate parameter, such as by using the ratio of students of each financial code and applying it to a price of vehicle, price of trip, or other grouping, or alternatively, calculating which financial code the majority of students are classified under and using that for the entire vehicle, trip, or other grouping, or alternatively, setting a priority order of assignment wherein certain financial codes trump all other codes as long as at least one student of that code is present on the vehicle, trip, or other grouping.

Generating an invoice 150 can allow a user to select which rate factors to display or hide, the order in which to display the rate factors, and whether to group calculated rates that are identical over a date range for concise display or expand for each day or time interval. In an example, such as that shown in FIG. 9, items listed on an invoice can include any of the following and/or a rate associated with any of the following: vehicle identifier, start date, end date, number of days, lift vehicle rate, enclosed vehicle rate, live duration for a given time of day (e.g., AM, mid-day, PM, activity hours, etc.), number of aides for a given time of day (e.g., AM, mid-day, PM, activity hours, etc.), a per-day rate, a subtotal amount for each grouping (e.g., for each vehicle), and a total amount. In an example, such as that shown in FIG. 10, items listed on an invoice can include any of the following and/or a rate associated with any of the following: student identifier, student financial code, special accommodations required for a student, start date, end date, number of days' routes, a per-day rate, a subtotal amount for each grouping (e.g., for each student), and a total amount. The forgoing are merely examples and not meant to be limiting in any way.

Transmitting invoice 160. The rate configurator 100 can further transmit an invoice to a client or other party. For example, the rate configurator 100 can transmit an invoice to a school, school district transportation network company, or any other entity. Herein, the term “invoice” can be used to describe both an accounting note requesting fees due for past services as well as an accounting note provided as a quote for prospective services. Thus, it should be understood that herein the term “invoice” need not be limited to services actually completed at the time of sending. The rate configurator 100 can also transmit an invoice to a government entity such as a state department of education and the like, such as where such entity is responsible for reimbursing transportation expenses or keeping records thereof. The rate configurator can transmit an invoice to a third party such as an audit firm or corporate efficiency consultant. An invoice can be transmitted by any method, including over wired or wireless communications networks including cellular networks, the internet, and the like.

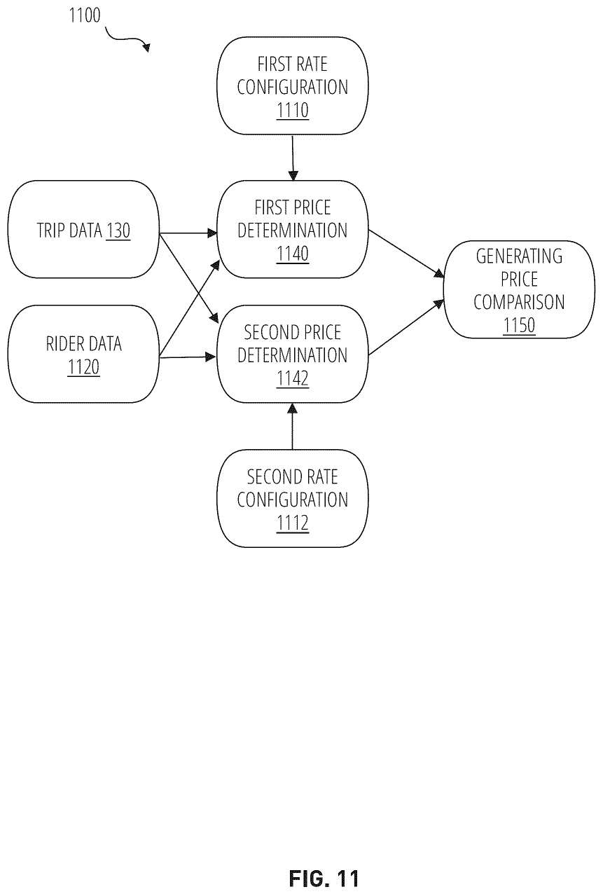

FIG. 11 is a diagram of an example rate comparison tool 1100. A rate comparison tool 1100 can be implemented as a process carried out on a computing device. The rate comparison tool 1100 can allow two or more rate configurations to be compared using a common set of trip data 1130 and rider data 1120. Using a rate comparison tool 1100, a user can thus compare two or more complex price quotations to determine which meets the user's needs when applied on sample data that can include the actual rider and trip data for transportation services needed by that user. For example, a school district can compare quotations received in response to an RFQ and see which is the least expensive when applied to the actual student data and routes required by that school district. Using such a tool thus allows a school district to accurately compare quotes in a way that is otherwise impracticable without the use of a rate comparison tool 1100.

The trip data 1130 of the rate comparison tool 1100 is generally the same as the trip data 130 described above with reference to FIGS. 1-8B. The rider data 1120 is generally the same as the rider data 1120 described above with reference to FIGS. 1-8B. In the example depicted by FIG. 11, a first rate configuration 1110 and a second rate configuration 1112 are used to illustrate the comparison of rate configurations. However, any number of additional rate configurations can be defined and compared using the rate comparison tool 1100. The first rate configuration 1110, the second rate configuration 1112, and any number of additional rate configurations can be defined using an interface and process that is substantially the same as the definition of rate categories 110 described above with reference to FIGS. 2-8B. For each of the first rate configuration 1110, the second rate configuration 1112, and any additional n^{th} rate configurations, the rate comparison tool 1100 performs a respective first price determination 1140, second price determination 1142, and n^{th} price determination by applying the trip data 1130 and rider data 1120 to each respective rate configuration to determine a price. Such price determinations are generally consistent with the price determination 140 described herein with reference to FIG. 1.

The rate comparison tool 1100 can create a price comparison 1150 that compares the first price determination 1142 with the second price determination 1142 and any additional price determinations made by the rate comparison tool 1100. The price comparison 1150 can display any information comparing the first price determination 1142 with the second price determination 1142 and any additional price determinations made by the rate comparison tool 1100. For example, the price comparison 1150 can display each total price, and can also provide additional information about each price determination such as that a user can use to compare different aspects of each price, such as an identification of which aspects of each price configuration that are the most significant to the total price.

In addition to the rate configurator tool 100 and price comparison tool 1100 disclosed herein, additional embodiments can include a tool for auditing invoices for transportation services that have already occurred. For example, a user contracting with a transportation provider for transportation services can use an auditing tool to compare an invoice for transportation services that have been rendered to the rate configuration, trip data, and rider data that are known to apply to the services that have been rendered. Such an auditing tool can allow a user to define the rate configuration consistent with the rate configuration 110 described herein with reference to FIGS. 1-8B, and then compare that rate configuration with trip data and rider data in the manner described herein to determine a reference price representing the price that should apply to the transaction. The price auditing tool can then compare the reference price to the price received in an invoice to determine whether any discrepancies exist. Such a tool can compare any number of invoices to any number of reference prices automatically.

The rate configurator tool 100, price comparison tool 1100, and any other system, process, or tool described herein can include additional features. In an example, the tools disclosed herein can integrate with other software. For example, the tools disclosed herein can receive student and trip data directly from a school's Student Information System (SIS). As another example, the system may be integrated with accounting software to provide invoices directly into an accounts payable/receivable location.

The rate configurator tool 100, price comparison tool 1100, and any other system, process, or tool described herein can be implemented by or more processing devices. The one or more processing devices can include a general-purpose processor or a special purpose processor. Instructions necessary to carry out the features and functions of tools disclosed herein can be stored (or otherwise embodied) on or in an appropriate storage medium or media (such a hard drive or other non-volatile storage) from which the instructions are readable by the processing device(s) for execution thereby. The one or more processing devices can be coupled to the storage medium or media to access the instructions therefrom. The instructions include the rate configurator tool 100, price comparison tool 1100, or other instructions which, when executed by the processing device(s), cause a computing device to perform the actions of the rate configurator tool 100, price comparison tool 1100, or other tools described herein. Processing devices can be implemented as a computing device, such as a general purpose computer. In some examples, the price comparison tool can be implemented entirely on a single computing device.

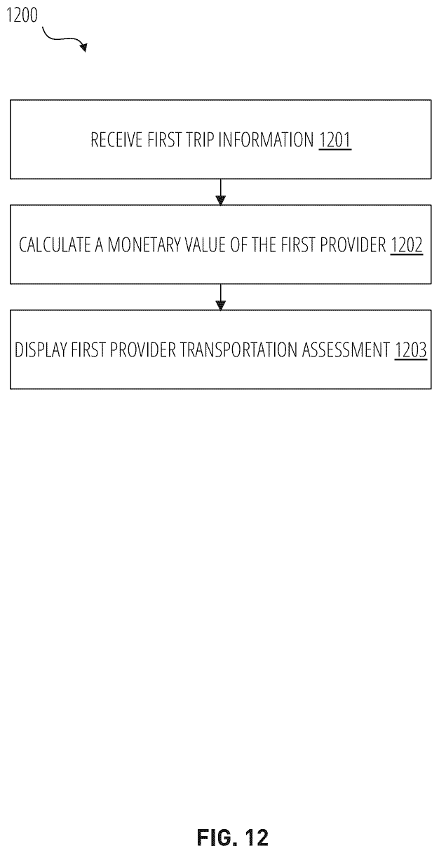

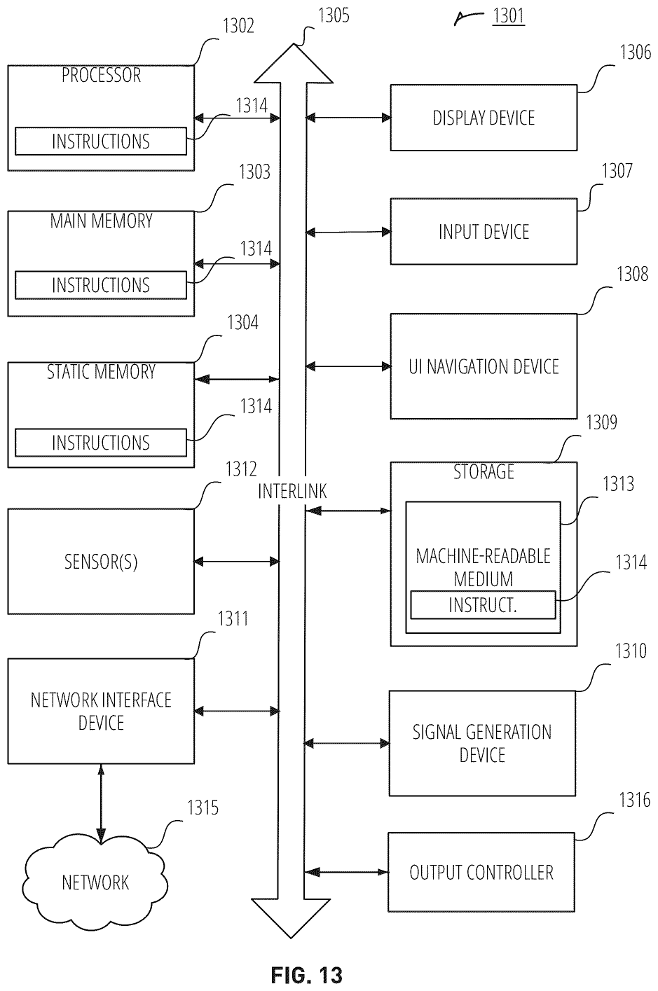

FIG. 12 is a flowchart describing a process 1200 assessing a value of a transportation service. For example, the process 1200 can be performed via the rate configuration tool 100 of FIG. 1 or one or more processors 1302 of the machine 1301 of FIG. 13.

At 1201, first trip information can be received, including data corresponding to a specified travel period associated with the first provider. This information can include specific parameters for multiple respective rides, e.g., mileage, travel duration, travel time-of-day, or location data for each individual ride. The system can receive, establish, or adjust a compound rate structure. For example, the compound rate structure can include a minimum, baseline compensation value, such as ensuring a base level of payment to the first provider for each trip. The compound rate structure can also include a qualified transportation compensation value, which can be established, e.g., by applying a qualified rate to the parameters included in the first trip information. For example, such a qualified transportation compensation value can allow for flexible pricing based on the specific characteristics of each ride. The compound rate structure can further include at least one cost-adjustment factor, which can be adjusted based on specified traveler classifications or trip classifications. For example, the cost-adjustment factor can be used such as to account for special circumstances or rider needs that may affect pricing.

At 1202, a monetary value of the specified travel period can be calculated for the first provider using the first trip information and the compound rate structure of the first rate configuration. The system can also present a first provider transportation assessment (e.g., a summary of the first trip information and the compound rate configuration) via a user interface, e.g., allowing users to determine the cost associated with the first provider. For example, such a user interface can display a detailed breakdown of certain provider-related costs and can also display respective factors influencing them.

In an example, the process 1200 can additionally involve comparing respective provider transportation assessments between multiple providers, such as to help optimizing or improve efficiency of route assignments based on a specified provider selection. For example, to facilitate such as comparison, the process 1200 can involve accessing a plurality of simulated, prospective trips, with each prospective trip corresponding to the first trip information. The monetary value of the specified travel period for the first provider can be compared with an estimated cost of a second provider. Based on this comparison, the system can automatically assign the specified prospective trip to the first provider.

In an example, the process 1200 can involve receiving telemetry data on a periodic basis from a plurality of vehicles in a fleet e.g., from trip routing or tracking software. Here, the telemetry data can correspond with respective specified travel periods, and first provider is associated with at least one vehicle of the fleet. Using this telemetry data, invoices can be generated automatically and recurringly, such as for multiple providers. For example, for the first provider, the invoice can be generated based on the determined monetary value of the specified period.

In an example, traveler data can additionally be received, the traveler data corresponding with the specified travel period. This traveler data can include specified traveler classifications corresponding to financial codes. For example, the financial codes can each indicate whether an individual traveler qualifies for a nonstandard travel pricing such as based on a need for a car seat, a school aide, a safety vest, or a lift vehicle for a wheelchair.

In an example, the process 1200 can include determining and accounting for deadhead time and intertrip time. Based on the raw trip data, an amount of deadhead time (time spent driving without passengers) and intertrip time can be calculated for each ride. The cost-adjustment factor in the rate configuration can then be applied based on this determined amount of deadhead time, such as to improve accuracy in pricing or cost-estimating. Once the monetary value for the specified travel period is determined, the process 1200 can involve automatically generating an invoice of fees due to the first provider. For example, the invoice can then be electronically delivered to either the first provider or to a recipient of services on behalf of the provider, further streamlining the billing or invoicing.

FIG. 13 illustrates generally an example of a block diagram of a machine 1301 upon which any one or more of the techniques (e.g., methodologies) discussed herein may perform in accordance with some examples. Alternatively, or additionally, the machine 1301 may operate as a standalone device or may be connected (e.g., networked) to other machines. In a networked deployment, the machine 1301 may operate in the capacity of a server machine, a client machine, or both in server-client network environments. In an example, the machine 1301 may act as a peer machine in peer-to-peer (P2P) (or other distributed) network environment. The machine 1301 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the execution units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 1301 may include a hardware processor 1302 (e.g., a central processing unit (CPU), a graphics processing unit (GPU), a hardware processor core, or any combination thereof), a main memory 1303 and a static memory 1304, some or all of which may communicate with each other via an interlink (e.g., bus) 1305. The machine 1301 may further include a display unit 1306, an alphanumeric input device 1307 (e.g., a keyboard), and a user interface (UI) navigation device 1308 (e.g., a mouse). In an example, the display unit 1306, alphanumeric input device 1307 and user interface (UI) navigation device 1308 may be a touch screen display. The machine 1301 may additionally include a storage device (e.g., drive unit) 1309, a signal generation device 1310 (e.g., a speaker), a network interface device 1311, and one or more sensors 1312, such as a global positioning system (GPS) sensor, compass, accelerometer, or other sensor. The machine 1301 may include an output controller 1316, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1309 may include a machine readable medium 1313 that is non-transitory on which is stored one or more sets of data structures or instructions 1314 (e.g., software) embodying or utilized by any one or more of the techniques or functions described herein. The instructions 1314 may also reside, completely or at least partially, within the main memory 1303, within static memory 1304, or within the hardware processor 1302 during execution thereof by the machine 1301. In an example, one or any combination of the hardware processor 1302, the main memory 1303, the static memory 1304, or the storage device 1309 may constitute machine readable media.

While the machine readable medium 1313 is illustrated as a single medium, the term “machine readable medium” may include a single medium or multiple media (e.g., a centralized or distributed database, or associated caches and servers) configured to store the one or more instructions 1314.

The term “machine readable medium” may include any medium that is capable of storing, encoding, or carrying instructions for execution by the machine 1301 and that cause the machine 1301 to perform any one or more of the techniques of the present disclosure, or that is capable of storing, encoding, or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1314 may further be transmitted or received over a communications network 1315 using a transmission medium via the network interface device 1311 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1311 may include one or more physical jacks (e.g., Ethernet, coaxial, or phone jacks) or one or more antennas to connect to the communications network 1315. In an example, the network interface device 1311 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1301, and includes digital or analog communications signals or other intangible medium to facilitate communication of such software.

The following, non-limiting examples, detail certain aspects of the present subject matter to solve the challenges and provide the benefits discussed herein, among others.

Example 1 is a method to assess a value of a transportation service, the method comprising: determining a first provider transportation assessment of a first provider, including: receiving first trip information corresponding with a specified travel period associated with the first provider, the first trip information including a first set of parameters corresponding with a plurality of rides, the first set of parameters including mileage, travel duration, and location data of an individual ride of the plurality of rides; establishing a compound rate structure, the compound rate structure including: a minimum, baseline compensation value; a qualified transportation compensation value, established based on applying a qualified rate to values of the first set of parameters included in the first trip information; and at least one cost-adjustment factor, adjustable at least based on a specified rider classification or a specified trip classification; determining a monetary value of the specified travel period, based on the first trip information and the compound rate structure, for the first provider; and displaying, via a user interface, the first provider transportation assessment for determining a cost associated with the first provider.

In Example 2, the subject matter of Example 1 includes, accessing a plurality of simulated prospective trips, an individual prospective trip corresponding with the first trip information; comparing the monetary value of the specified travel period, corresponding with the first trip information of the first provider, with an estimated cost of a second provider; and automatically assigning the specified prospective trip of the plurality of simulated, prospective trips between either the first provider or a second provider based on the comparison.

In Example 3, the subject matter of Examples 1-2 includes, receiving, on a periodic basis from a plurality of vehicles in a fleet of vehicles, respective telemetry data received from trip telemetry software, corresponding with respective specified travel periods; wherein the first provider is associated with at least one vehicle of the fleet of vehicles.

In Example 4, the subject matter of Example 3 includes, automatically and recurringly generating invoices for a plurality of providers based on the respective telemetry data, an invoice for the first provider based on the determined monetary value of the specified period.

In Example 5, the subject matter of Examples 1˜4 includes, wherein the trip information includes raw trip data received from trip routing or tracking software and corresponding with the specified travel period, wherein the first set of parameters included in the first trip information are recorded values included in the raw trip data.

In Example 6, the subject matter of Example 5 includes, receiving rider data corresponding with the specified travel period, the rider data including the specified rider classification corresponding with a rider qualifier, the rider qualifier indicating whether an individual traveler qualifies for nonstandard travel pricing.

In Example 7, the subject matter of Example 6 includes, route.

In Example 8, the subject matter of Examples 6-7 includes, wherein the rider qualifier is an indication of a need for a ride accommodation including at least one of a need for a car seat, an aide, a safety vest, a lift vehicle for a wheelchair, solo transport, a barrier vehicle, or a seat belt locking cover.

In Example 9, the subject matter of Examples 5-8 includes, determining, based on the raw trip data, an amount of deadhead time and an amount of intertrip time corresponding with an individual ride of the plurality of rides; wherein the at least one cost-adjustment factor includes cost adjustment based on the determined amount of deadhead time.

In Example 10, the subject matter of Example 9 includes, determining an amount of deadhead mileage or distance corresponding with the deadhead time.

In Example 11, the subject matter of Examples 6-10 includes, automatically generating a statement of fees due to the first provider for the specified travel period; and triggering electronic delivering of the statement to at least one of the first provider or to a recipient of services on behalf of the first provider.

In Example 12, the subject matter of Examples 1-11 includes, determining a second provider transportation assessment of a second provider, including: receiving second trip information corresponding with a second specified travel period associated with the second provider, the second trip information including a second set of parameters corresponding with a second plurality of rides, the second set of parameters including mileage, travel duration, and location data of an individual ride of the plurality of rides; establishing a second compound rate structure, the second compound rate structure including: a second minimum, baseline compensation value; a second qualified transportation compensation value, established based on applying a second qualified rate to values of the second set of parameters included in the second trip information; and at least one second cost-adjustment factor, adjustable at least based on a second specified traveler classification or a second specified trip classification; determining a second monetary value of the second specified travel period, based on the second trip information and the second compound rate structure, for the second provider; and displaying, via the user interface, the second provider transportation assessment for determining a second cost associated with the second provider.

In Example 13, the subject matter of Example 12 includes, comparing the first provider transportation assessment with the second provider transportation assessment to determine a difference in value between the first and second provider, wherein the first trip information and the second trip information correspond to a same trip.

Example 14 is a non-transitory computer-readable storage medium, the computer-readable storage medium including instructions that when executed by a computer, cause the computer to: determine a first provider transportation assessment of a first provider, including: receive first trip information corresponding with a specified travel period associated with the first provider, the first trip information including parameters corresponding with a plurality of rides, the parameters including mileage, travel duration, and location data of an individual ride of the plurality of rides; establish a first rate configuration including a compound rate structure, the compound rate structure including: a minimum, baseline compensation value; a qualified transportation compensation value, established based on applying a qualified rate to values of parameters included in the first trip information; and at least one cost-adjustment factor, adjustable at least based on a specified traveler classification or a specified trip classification; determine a monetary value of the specified travel period, based on the first trip information and the compound rate structure of the first rate configuration, for the first provider; and display, via a user interface, the first provider transportation assessment for determining a cost associated with the first provider.

In Example 15, the subject matter of Example 14 includes, wherein the computer-readable storage medium includes instructions that when executed by a computer, cause the computer to: access a plurality of simulated, prospective trips, an individual prospective trip corresponding with the first trip information; compare the monetary value of the specified travel period, corresponding with the first trip information of the first provider, with an estimated cost of a second provider; and automatically assign the specified prospective trip of the plurality of simulated, prospective trips between either the first provider or a second provider based on the comparison.

In Example 16, the subject matter of Examples 14-15 includes, wherein the computer-readable storage medium includes instructions that when executed by a computer, cause the computer to receive, on a periodic basis from a plurality of vehicles in a fleet of vehicles, respective telemetry data received from trip routing or tracking software and corresponding with respective specified travel periods; wherein the first provider is associated with at least one vehicle of the fleet of vehicles.

In Example 17, the subject matter of Example 16 includes, wherein the computer-readable storage medium includes instructions that when executed by a computer, cause the computer to automatically and recurringly generate an invoice for a plurality of providers based on the respective telemetry data, the invoice for the first provider based on the determined monetary value of the specified period.

In Example 18, the subject matter of Examples 14-17 includes, wherein the trip information includes raw trip data received from trip rout or tracking software and corresponding with the specified travel period, wherein the parameters included in the first trip information are recorded values included in the raw trip data.

In Example 19, the subject matter of Example 18 includes, wherein the computer-readable storage medium includes instructions that when executed by a computer, cause the computer to receive traveler data corresponding with the specified travel period, the traveler data including the specified traveler classification corresponding with a rider qualifier, the rider qualifier indicating whether an individual traveler qualifies for nonstandard travel pricing.

In Example 20, the subject matter of Example 19 includes, route.

In Example 21, the subject matter of Examples 19-20 includes, wherein the rider qualifier is an indication of a need for a ride accommodation including at least one of a need for a car seat, an aide, a safety vest, a lift vehicle for a wheelchair, solo transport, a barrier vehicle, or a seat belt locking cover.

In Example 22, the subject matter of Examples 18-21 includes, wherein the computer-readable storage medium includes instructions that when executed by a computer, cause the computer to: determine, based on the raw trip data, an amount of deadhead time and an amount of intertrip time corresponding with an individual ride of the plurality of rides; wherein the at least one cost-adjustment factor includes cost-adjustment based on the determined amount of deadhead time.

In Example 23, the subject matter of Example 22 includes, wherein the computer-readable storage medium includes instructions that when executed by a computer, cause the computer to determine an amount of deadhead mileage or distance corresponding with the deadhead time.

In Example 24, the subject matter of Examples 19-23 includes, wherein the computer-readable storage medium includes instructions that when executed by a computer, cause the computer to: automatically generate a statement of fees due to the first provider for the specified travel period; and trigger electronic delivering of the statement to at least one of the first provider or to a recipient of services on behalf of the provider.

In Example 25, the subject matter of Examples 14-24 includes, wherein the computer-readable storage medium includes instructions that when executed by a computer, cause the computer to: determine a second provider transportation assessment, including: receive second trip information corresponding with a specified travel period associated with the second provider, the second trip information including parameters corresponding with a plurality of rides, the parameters including mileage, travel duration, and location data of an individual ride of the plurality of rides; establish a second rate configuration including a compound rate structure, the compound rate structure including: a minimum, baseline compensation value; a qualified transportation compensation value, established based on applying a qualified rate to values of parameters included in the first trip information; and at least one cost-adjustment factor, adjustable at least based on a specified traveler classification or a specified trip classification; determine a monetary value of the specified travel period, based on the second trip information and the compound rate structure of the second rate configuration, for the second provider; and display, via a user interface, the second provider transportation assessment for determining a cost associated with the second provider.

In Example 26, the subject matter of Example 25 includes, wherein the computer-readable storage medium includes instructions that when executed by a computer, cause the computer to compare the first provider transportation assessment with the second provider transportation assessment to determine a difference in value between the first and second provider, wherein the first trip information and the second trip information correspond to a same actual or simulated trip.

Example 27 is at least one machine-readable medium including instructions that, when executed by processing circuitry, cause the processing circuitry to perform operations to implement of any of Examples 1-26.

Example 28 is an apparatus comprising means to implement of any of Examples 1-26.

Example 29 is a system to implement of any of Examples 1-26.

Example 30 is a method to implement of any of Examples 1-26.

The above Detailed Description can include references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method to assess a value of a transportation service, the method comprising:
determining a first provider transportation assessment of a first provider, including:
receiving first trip information corresponding with a specified travel period associated with the first provider, the first trip information including a first set of parameters corresponding with a plurality of rides, the first set of parameters including mileage, travel duration, and location data of an individual ride of the plurality of rides;
establishing a compound rate structure, the compound rate structure including:
a minimum, baseline compensation value;
a qualified transportation compensation value, established based on applying a qualified rate to values of the first set of parameters included in the first trip information; and
at least one cost-adjustment factor, adjustable at least based on a specified rider classification or a specified trip classification;
determining a monetary value of the specified travel period, based on the first trip information and the compound rate structure, for the first provider; and
displaying, via a user interface, the first provider transportation assessment for determining a cost associated with the first provider.

2. The method of claim 1, comprising:
accessing a plurality of simulated prospective trips, an individual prospective trip corresponding with the first trip information;
comparing the monetary value of the specified travel period, corresponding with the first trip information of the first provider, with an estimated cost of a second provider; and
automatically assigning the specified prospective trip of the plurality of simulated, prospective trips between either the first provider or a second provider based on the comparison.

3. The method of claim 1, comprising receiving, on a periodic basis from a plurality of vehicles in a fleet of vehicles, respective telemetry data received from trip telemetry software, corresponding with respective specified travel periods;
wherein the first provider is associated with at least one vehicle of the fleet of vehicles.

4. The method of claim 3, comprising automatically and recurringly generating invoices for a plurality of providers based on the respective telemetry data, an invoice for the first provider based on the determined monetary value of the specified period.

5. The method of claim 1, wherein the trip information includes raw trip data received from trip routing or tracking software and corresponding with the specified travel period, wherein the first set of parameters included in the first trip information are recorded values included in the raw trip data.

6. The method of claim 5, comprising receiving rider data corresponding with the specified travel period, the rider data including the specified rider classification corresponding with a rider qualifier, the rider qualifier indicating whether an individual traveler qualifies for nonstandard travel pricing.

7. The method of claim 6, wherein the rider qualifier is a financial code indicative of rider information, the financial code indicating whether the rider is classified by a governing entity as at least one of general education, special education, homeless, or eligible for a section 504 route.

8. The method of claim 6, wherein the rider qualifier is an indication of a need for a ride accommodation including at least one of a need for a car seat, an aide, a safety vest, a lift vehicle for a wheelchair, solo transport, a barrier vehicle, or a seat belt locking cover.

9. The method of claim 5, comprising:
determining, based on the raw trip data, an amount of deadhead time and an amount of intertrip time corresponding with an individual ride of the plurality of rides;
wherein the at least one cost-adjustment factor includes cost adjustment based on the determined amount of deadhead time.

10. The method of claim 9, comprising determining an amount of deadhead mileage or distance corresponding with the deadhead time.

11. The method of claim 6, comprising:
automatically generating a statement of fees due to the first provider for the specified travel period; and
triggering electronic delivering of the statement to at least one of the first provider or to a recipient of services on behalf of the first provider.

12. The method of claim 1, comprising:
determining a second provider transportation assessment of a second provider, including:
receiving second trip information corresponding with a second specified travel period associated with the second provider, the second trip information including a second set of parameters corresponding with a second plurality of rides, the second set of parameters including mileage, travel duration, and location data of an individual ride of the plurality of rides;
establishing a second compound rate structure, the second compound rate structure including:
a second minimum, baseline compensation value;
a second qualified transportation compensation value, established based on applying a second qualified rate to values of the second set of parameters included in the second trip information; and
at least one second cost-adjustment factor, adjustable at least based on a second specified traveler classification or a second specified trip classification;
determining a second monetary value of the second specified travel period, based on the second trip information and the second compound rate structure, for the second provider; and
displaying, via the user interface, the second provider transportation assessment for determining a second cost associated with the second provider.

13. The method of claim 12, comprising comparing the first provider transportation assessment with the second provider transportation assessment to determine a difference in value between the first and second provider, wherein the first trip information and the second trip information correspond to a same trip.

14. A non-transitory computer-readable storage medium, the computer-readable storage medium including instructions that when executed by a computer, cause the computer to:
determine a first provider transportation assessment of a first provider, including:
receive first trip information corresponding with a specified travel period associated with the first provider, the first trip information including parameters corresponding with a plurality of rides, the parameters including mileage, travel duration, and location data of an individual ride of the plurality of rides;
establish a first rate configuration including a compound rate structure, the compound rate structure including:
a minimum, baseline compensation value;
a qualified transportation compensation value, established based on applying a qualified rate to values of parameters included in the first trip information; and
at least one cost-adjustment factor, adjustable at least based on a specified traveler classification or a specified trip classification;
determine a monetary value of the specified travel period, based on the first trip information and the compound rate structure of the first rate configuration, for the first provider; and
display, via a user interface, the first provider transportation assessment for determining a cost associated with the first provider.

15. The computer-readable storage medium of claim 14, wherein the computer-readable storage medium includes instructions that when executed by a computer, cause the computer to:
access a plurality of simulated, prospective trips, an individual prospective trip corresponding with the first trip information;
compare the monetary value of the specified travel period, corresponding with the first trip information of the first provider, with an estimated cost of a second provider; and
automatically assign the specified prospective trip of the plurality of simulated, prospective trips between either the first provider or a second provider based on the comparison.

16. The computer-readable storage medium of claim 14, wherein the computer-readable storage medium includes instructions that when executed by a computer, cause the computer to receive, on a periodic basis from a plurality of vehicles in a fleet of vehicles, respective telemetry data received from trip routing or tracking software and corresponding with respective specified travel periods;
wherein the first provider is associated with at least one vehicle of the fleet of vehicles.

17. The computer-readable storage medium of claim 16, wherein the computer-readable storage medium includes instructions that when executed by a computer, cause the computer to automatically and recurringly generate an invoice for a plurality of providers based on the respective telemetry data, the invoice for the first provider based on the determined monetary value of the specified period.

18. The computer-readable storage medium of claim 14, wherein the trip information includes raw trip data received from trip rout or tracking software and corresponding with the specified travel period, wherein the parameters included in the first trip information are recorded values included in the raw trip data.

19. The computer-readable storage medium of claim 18, wherein the computer-readable storage medium includes instructions that when executed by a computer, cause the computer to receive traveler data corresponding with the specified travel period, the traveler data including the specified traveler classification corresponding with a rider qualifier, the rider qualifier indicating whether an individual traveler qualifies for nonstandard travel pricing.

20. The computer-readable storage medium of claim 19, wherein the rider qualifier is a financial code is indicative of rider information, the financial code indicating whether the rider is classified by a governing entity as at least one of general education, special education, homeless, or eligible for a section 504 route.

21. The computer-readable storage medium of claim 19, wherein the rider qualifier is an indication of a need for a ride accommodation including at least one of a need for a car seat, an aide, a safety vest, a lift vehicle for a wheelchair, solo transport, a barrier vehicle, or a seat belt locking cover.

22. The computer-readable storage medium of claim 18, wherein the computer-readable storage medium includes instructions that when executed by a computer, cause the computer to:
determine, based on the raw trip data, an amount of deadhead time and an amount of intertrip time corresponding with an individual ride of the plurality of rides;
wherein the at least one cost-adjustment factor includes cost-adjustment based on the determined amount of deadhead time.

23. The computer-readable storage medium of claim 22, wherein the computer-readable storage medium includes instructions that when executed by a computer, cause the computer to determine an amount of deadhead mileage or distance corresponding with the deadhead time.

24. The computer-readable storage medium of claim 19, wherein the computer-readable storage medium includes instructions that when executed by a computer, cause the computer to:
automatically generate a statement of fees due to the first provider for the specified travel period; and
trigger electronic delivering of the statement to at least one of the first provider or to a recipient of services on behalf of the provider.

25. The computer-readable storage medium of claim 14, wherein the computer-readable storage medium includes instructions that when executed by a computer, cause the computer to:
determine a second provider transportation assessment, including:
receive second trip information corresponding with a specified travel period associated with the second provider, the second trip information including parameters corresponding with a plurality of rides, the parameters including mileage, travel duration, and location data of an individual ride of the plurality of rides;
establish a second rate configuration including a compound rate structure, the compound rate structure including:
a minimum, baseline compensation value;
a qualified transportation compensation value, established based on applying a qualified rate to values of parameters included in the first trip information; and
at least one cost-adjustment factor, adjustable at least based on a specified traveler classification or a specified trip classification;
determine a monetary value of the specified travel period, based on the second trip information and the compound rate structure of the second rate configuration, for the second provider; and
display, via a user interface, the second provider transportation assessment for determining a cost associated with the second provider.

26. The computer-readable storage medium of claim 25, wherein the computer-readable storage medium includes instructions that when executed by a computer, cause the computer to compare the first provider transportation assessment with the second provider transportation assessment to determine a difference in value between the first and second provider, wherein the first trip information and the second trip information correspond to a same actual or simulated trip.
